(19) United States
(12) Patent Application Publication
(10) Pub. No.: US 2026/0044578 A1
(43) Pub. Date: Feb. 12, 2026

(54) SYSTEMS AND METHODS FOR DETERMINING THE OPTIMAL THRESHOLD FOR IMBALANCED DATA CLASSIFICATION

(71) Applicant: WELLS FARGO BANK, N.A., San Francisco, CA (US)

(72) Inventors: Shahnam Khabiri, Falls Church, VA (US); Jia Gao, Charlotte, NC (US)

(21) Appl. No.: 18/799,420

(22) Filed: Aug. 9, 2024

(51) Int. Cl. G06F 18/2413; G06F 18/10; G06N 20/00

(52) U.S. Cl. CPC G06F 18/2413; G06F 18/10; G06N 20/00

(57) ABSTRACT

A method of selecting an optimal threshold value for a pretrained machine learning model of a classifier service is provided. The method includes accessing a set of samples and a set of predefined threshold values and performing class prediction on each sample by generating a set of class probabilities. The method also includes generating a precision value and a recall value associated with the set of samples and set of predefined threshold values. The method also includes generating a reference precision value. The method also includes normalizing the set of precision ratios and determining a set of normalized lift ratios based on the recall values and the normalized precision ratio values. The method also includes selecting an optimal threshold value based on the set of normalized lift ratios and classifying the set of samples using the set of class probabilities and the optimal threshold value.

### TECHNICAL FIELD

Embodiments of the present disclosure generally relate to machine learning, and more particularly to integrated techniques for determining the optimal threshold value for imbalanced data classification.

### BACKGROUND

Imbalanced data classification may refer to a dataset with a skewed class distribution. For example, in a binary (two-class) classification task, most of the samples of an imbalanced dataset belong to class 0 (e.g., the majority class) with only a few examples in class 1 (e.g., the minority class). In such binary classification problems, it is common for the majority class to represent a normal case in the domain, whereas the minority class represents an abnormal case, such as a fault, fraud, outlier, anomaly, disease state, and so on. Additionally, for imbalanced datasets, the interpretation of misclassification errors may differ across classes. For example, misclassifying a sample from the majority class as a sample from the minority class (false positive) is often not desired, but can be less critical than classifying an example from the minority class as belonging to the majority class (false negative). More specifically, in the case of fraud detection, it is more important to identify the case of fraud than identify the case of non-fraud. Binary classifiers may be trained to predict the rare positive class (e.g., the case of fraud), and one technique to control the rate of prediction is by adjusting the threshold value of the classifier. In general, reducing the threshold value of the classifier, increases the number of positive (rare class) predictions. This applies to both true positive (TP) predictions (e.g., correct predictions) as well as false positive (FP) predictions (e.g., incorrect predictions).

Identifying cases in the positive class (e.g., TP predictions) is more important than identifying cases in the negative class; thus, it is desirable to lower the threshold value to identify more positive predictions. However, while lowering the threshold value results in more TP predictions, this result comes at the cost of also identifying more FP predictions. In the case of severely imbalanced data (e.g., a majority-to-minority class ratio between 100:1 and 10,000:1) consequences can result from predicting a significant number of FP in return for a marginal increase in TP predictions. As such, there is a need in the art for improved techniques for selecting an optimized threshold value that appropriately balances TP and FP predictions.

### SUMMARY

Certain aspects and features of the present disclosure generally relate to machine learning, and more particularly to integrated techniques for determining the optimal threshold value for imbalanced data classification. According to an aspect of the present disclosure, a method of selecting an optimal threshold value for a pretrained machine learning model of a classifier service is provided. The method includes accessing a set of samples and a set of predefined threshold values. The method also includes performing class prediction on each sample of the set of samples using a prediction module to generate a set of class probabilities. Each sample of the set of samples is predicted to be associated with a particular class of a set of classes based on a selected threshold value from the set of predefined threshold values and a class probability. The method also includes generating a reference precision value using a pre-processing module. The method also includes generating, using the pre-processing module, a recall value associated with each predefined threshold value to thereby generate a set of recall values. The method also includes generating, using the pre-processing module, a set of precision values associated with each predefined threshold value to thereby generate a set of precision values. The method also includes generating a set of precision ratio values using the pre-processing module, wherein generating the set of precision ratio values comprises dividing each precision value by the reference precision value. The method also includes normalizing the set of precision ratio values using a normalization module to thereby generate a normalized set of precision ratio values by determining a maximum precision ratio value of the set of precision ratio values and dividing each precision ratio value by the maximum precision ratio value. The method also includes providing the set of recall values and the normalized set of precision ratio values to an optimization module and determining a set of normalized lift ratios based on the set of recall values and the normalized set of precision ratio values. The method also includes selecting an optimal threshold value based on the set of normalized lift ratios and classifying the set of samples using the optimal threshold value and the set of class probabilities generated by the pretrained machine learning model of the classifier service.

The above methods may be implemented in a cloud service executed on cloud service provider infrastructure, which may include various servers, processors, and databases. The above methods can also be implemented as computer-executable program instructions stored in a non-transitory, tangible computer-readable medium or media and/or operating within a system including one or more processors or other processing device and memory.

An additional example includes a system including one or more processors. The system also includes a memory coupled to the one or more processors. The memory includes instructions that when executed by the one or more processors, causes the one or more processors to: access a set of samples and a set of predefined threshold values; perform class prediction on each sample of the set of samples using a prediction module to generate a set of class probabilities wherein, each sample of the set of samples is predicted to be associated with a particular class of a set of classes based on a selected threshold value from the set of predefined threshold values and a class probability; generate a reference precision value associated using a pre-processing module; generate a recall value associated with each predefined threshold value using the pre-processing module to thereby generate a set of recall values; generate a precision value associated with each predefined threshold value using the pre-processing module to thereby generate a set of precision values; generate a set of precision ratio values using the pre-processing module, wherein generating the set of precision ratio values comprises dividing each precision value by the reference precision value; normalize the set of precision ratio values using a normalization module to thereby generate a normalized set of precision ratio values by: determining a maximum precision ratio value of the set of precision ratio values; and dividing each precision ratio value by the maximum precision ratio value; provide the set of recall values and the normalized set of precision ratio values to an optimization module; determine a set of normalized lift ratios based on the set of recall values and the normalized set of precision ratio values; select an optimal threshold value based on the set of normalized lift ratios; and classify the set of samples using the set of class probabilities and the optimal threshold value.

An additional example includes a non-transitory computer-readable medium embodying program code that is executable by one or more processors to cause the one or more processors to: access a set of samples and a set of predefined threshold values; perform class prediction on each sample of the set of samples using a prediction module to generate a set of class probabilities wherein, each sample of the set of samples is predicted to be associated with a particular class of a set of classes based on a selected threshold value from the set of predefined threshold values and a class probability; generate a reference precision value associated using a pre-processing module; generate a recall value associated with each predefined threshold value using the pre-processing module to thereby generate a set of recall values; generate a precision value associated with each predefined threshold value using the pre-processing module to thereby generate a set of precision values; generate a set of precision ratio values using the pre-processing module, wherein generating the set of precision ratio values comprises dividing each precision value by the reference precision value; normalize the set of precision ratio values using a normalization module to thereby generate a normalized set of precision ratio values by: determining a maximum precision ratio value of the set of precision ratio values; and dividing each precision ratio value by the maximum precision ratio value; provide the set of recall values and the normalized set of precision ratio values to an optimization module; determine a set of normalized lift ratios based on the set of recall values and the normalized set of precision ratio values; select an optimal threshold value based on the set of normalized lift ratios; and classify the set of samples using the set of class probabilities and the optimal threshold value.

Numerous benefits are achieved by way of the various embodiments over conventional techniques. For example, examples of the present disclosure provide techniques for determining the optimal threshold value for imbalanced data classification. The determined optimal threshold value provides an appropriate balance between TP and FP predictions by quantifying a tradeoff between recall and precision metrics of a classifier. In particular, the techniques described herein define a new metric referred to as normalized lift ratio where maximizing the normalized lift ratio curve provides the optimal threshold value. Additionally, because the newly defined normalized lift ratio metric is dependent on precision and recall, the metric appropriately balances the tradeoff between the number of correctly predicted minority class predictions with the relevancy of all minority class predictions thereby enabling the ability to select a specific optimized threshold value through providing a distinct optimum point on the normalized lift ratio curve.

This summary is not intended to identify the key or essential features of the claimed subject matter, nor is it intended to be used in isolation to determine the scope of the claimed subject matter. Rather, the summary is merely a simplified and non-limiting summary of the innovation that is intended to provide a basic understanding of some aspects of the innovation. The subject matter should be understood by reference to appropriate portions of the entire specification of this disclosure, any or all drawings, and each claim.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings, in which:

FIG. 1 is a block diagram illustrating an example threshold value optimization system for selecting an optimal threshold value for a pretrained machine learning model of a classifier service, according to one or more aspects of the present disclosure;

FIG. 2 is a block diagram illustrating an example computing platform used for threshold value optimization, according to one or more aspects of the present disclosure;

FIG. 3 is a block diagram illustrating an example analysis pipeline of the computing platform of FIG. 2 used for threshold value optimization, according to one or more aspects of the present disclosure;

FIG. 4 is an example plot of normalized lift ratios verse predefined threshold values, according to one or more aspects of the present disclosure;

FIG. 5 is a flowchart of an example of a process for selecting an optimal threshold value for a pretrained machine learning model of a classifier service, according to one or more aspects of the present disclosure;

FIG. 6 is a block diagram illustrating an example computer-readable medium or computer-readable device including processor-executable instructions configured to embody one or more aspects of the present disclosure; and

FIG. 7 is an example of a suitable computing environment to implement embodiments of one or more aspects of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs.

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

Utilizing common evaluation metrics for classification of imbalanced datasets can lead to sub-optimal classification models and that may produce misleading conclusions since the common metrics are insensitive to skewed domains. For example, in a classification problem where 99% of the examples are negative (e.g., 99% of the examples represent the “normal” case), a no-skill model that predicts all the examples as negative achieves a 99% accuracy. This may be representing by the following accuracy equation:

$$Accuracy = \frac{TP + TN}{TP + TN + FP + FN}$$

In the Accuracy equation above and as used throughout the present disclosure, TP may represent the true positive class. In a dataset, the TP class represents a sample that is correctly predicted in the minority class. TN represent the true negative (TN) class. In a dataset, the TN class represents a sample that is correctly predicted in the majority class. FP represents the false positive class. In a dataset, the FP class represents a sample that is incorrectly predicted to be in the minority class (e.g., in the case of fraud, a FP sample is a case of non-fraud that is identified as fraud). FN represents the false negative (FN) class. In a dataset, the FN class represents a sample that is incorrectly predicted to be in the majority class (e.g., in the case of fraud, a FN sample is a case of fraud that is identified as non-fraud).

The common evaluation metrics discussed above treat all classes as equally important. In other words, incorrectly classifying a sample as belong to the TP or TN class is treated as equivalent. However, for imbalanced classification problems, it is often more important to correctly identify the minority (positive) class as compared to the majority (negative) class. One technique to approach imbalanced data classification utilizes evaluation metrics such as precision and recall. Precision and recall metrics put more emphasis on the minority (positive) class and may be represented by the following equations:

$$Precision = \frac{TP}{TP + FP} , Recall = \frac{TP}{TP + FN}$$

Using the precision and recall values, a precision-recall curve can be generated where the precision-recall curve focuses on the performance of the classifier on the minority class. In the example of a no-skill classifier, the precision-recall curve will have a horizontal line that is proportional to the number of positive examples in the dataset. For illustrative purposes, this means that if the dataset is perfectly balanced (e.g., the number of samples in the positive class is equivalent to the number of samples in the negative class), the precision-recall curve will be a horizonal line at 0.5 for a no-skill classifier. If it were the case that the classifier was perfect, the precision-recall curve would be the maximum of both precision and recall (e.g., at the top right of the plot).

Adjusting the threshold value of a classifier can adjust the precision and recall values, and selecting an appropriate threshold value can optimize the performance of a classifier. Thus, the optimized threshold value represents a tradeoff between each of the precision metric and the recall metric. One mechanism to select a threshold value of a classifier with imbalanced data is by utilizing an F1-score. In general, F1-score is a harmonic mean of precision and recall, where the relative contribution of precision and recall metrics to the F1-score are equivalent. Maximizing the F1-score results can generate a threshold value (e.g., an F1-score closer to 1 is more desirable). F1-score may be represented by the following equation:

$$F 1 = 2 \times \frac{Precision \times Recall}{Precision + Recall}$$

However, in the case of a severely imbalanced dataset (e.g., a majority-to-minority class ratio of 100:1, 10,000:1, 100,000:1, etc.), the generated precision value can be as low as a fraction of a basis point (e.g., because TP divided by the sum of TP plus FP will be a very small value). Thus, F1-score, which is dependent on precision, can also be as low as a fraction of a basis point. The insignificance of this F1-score renders it meaningless and irrelevant to make a judgement about the performance of the classifier and the selected threshold value. One mechanism to fix the issues associated with severely imbalanced data classification is to leverage the cost of the business decisions (e.g., using a cost function and/or through trial and error) associated with classifier predictions. However, the cost of TP, FP, FN can vary depending on the particular application (e.g., fault detection, fraud detection, disease detection, etc.). Thus, while using a cost function may satisfy the particular need of the application, the cost function may not reflect the optimum performance of the classifier in terms of its classification skill. Thus, there is a need in the art for a mechanism of determining the optimal threshold value for imbalanced data classification.

### Illustrative Example of Determining the Optimal Threshold Value for Imbalanced Data Classification

The techniques described in relation to the illustrative example are described with reference to a binary classifier (herein after “classifier”). However, the techniques may be extended and generalized to multi-class classifiers. One of ordinary skill in the art would recognize many variations, modifications, and alternatives.

As previously described, to optimize the performance of a classifier, an optimal threshold value may be selected, where the optimal threshold value represents a tradeoff between precision and recall. To select the optimal threshold value for a classifier, a threshold value optimization system is provided that receives input data. The input data includes a severely imbalanced dataset and a set of predefined threshold values. The threshold value optimization system includes a prediction module, a pre-processing module, a normalization module, and an optimization module configured to generate an optimal threshold value for downstream classification problems. The prediction module receives the input data and performs class prediction on each sample from the dataset. Performing class prediction on each sample from the dataset includes generating a set of class probabilities. For example, based on a specific threshold value from the predefined threshold values and a class probability from the set of class probabilities, each sample will be predicted as belonging to a particular class. A first class can be associated with a true negative class (e.g., majority class) and a second class can be associated with a true positive class (e.g., minority class). After generating the set of class probabilities, the prediction module can provide the probability prediction for each class to a pre-processing module.

The pre-processing module can receive the class probability for each sample and based on the specific threshold value perform pre-processing metrics. The pre-processing metrics include determining a set of precision values and determining a set of recall values associated with the dataset using the equations described previously. Additionally, the pre-processing module can generate a reference precision value associated with the input data. Determining the reference precision values involves dividing a number of samples associated with the minority class by a sum of the number of samples associated with the minority class and a number of samples associated with the majority class. The pre-processing module also generates a set of precision ratio values based on the reference precision value and the set of precision values. The pre-processing module can then provide the set of recall values and the set of precision ratio values to a normalization module.

The normalization module can normalize the set of precision ratio values to thereby generate a normalized set of precision ratio values. To normalize the set of precision ratio values, the normalization module determines a maximum precision ratio value from the set of precision ratio values and divides each precision ratio value by the determined maximum precision ratio value. The normalization module then provides the normalized set of precision ratio values and the set of recall values to an optimization module.

The optimization module determines a set of normalized lift ratios based on the set of recall values and the normalized set of precision ratio values. Determining the set of normalized lift ratios includes determining a harmonic average of the set of normalize precision ratio value and the set of recall values. The harmonic average representing the set of normalized lift ratios may be expressed by the following equation:

$$Normalized lift {ratio}_{l} = \frac{2}{\frac{1}{{recall}_{l}} + \frac{1}{Normalized Precision Ratio {Value}_{l}}}$$

As expressed in the equation above, recall, represents the recall value for each predefined threshold value, and Normalized Precision Ratio represents the normalized set of precision ratio values.

After the set of normalized lift ratios are generated, the optimization module can select the optimal threshold value from the set of normalized lift ratios. Selecting the optimal threshold value includes determining a maximum value of the set of normalized lift ratios. The optimal threshold value is then used by the pretrained machine learning model of the classifier service to classify the set of samples using the set of class probabilities and the optimal threshold value.

While certain embodiments are described, these embodiments are presented by way of example only and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection. Further details regarding the systems and methods are provided below in relation to the drawings.

### Illustrative Systems and Methods of Determining the Optimal Threshold Value for Imbalanced Data Classification

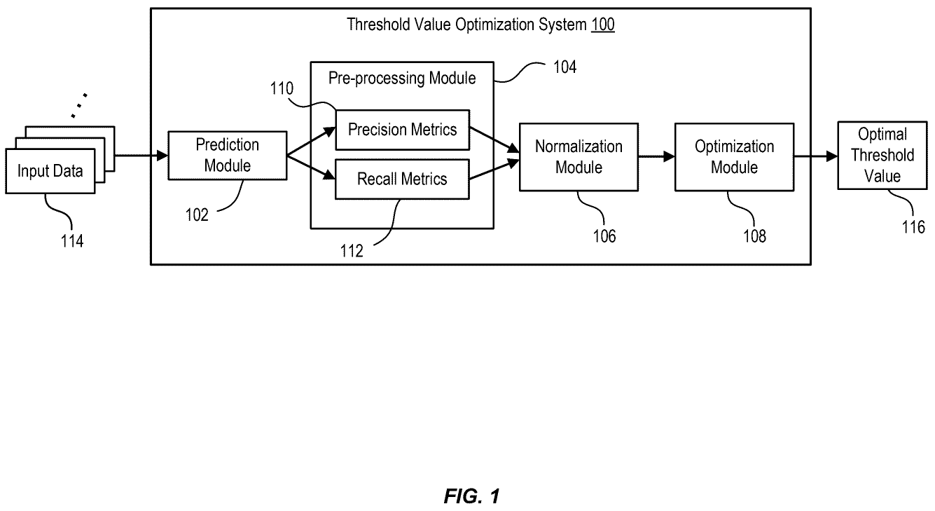

Turning now to the figures, FIG. 1 is a block diagram illustrating an example threshold value optimization system 100 for selecting an optimal threshold value for a pretrained machine learning model of a classifier service, according to one or more aspects of the present disclosure. The techniques described in relation to the threshold value optimization system 100 are described in relation to providing an optimal threshold value 116 to a pretrained machine learning model of a classifier service, such as a binary classifier. However, the techniques described herein may be generalized to a multi-class classifier depending on the particular application.

In general, with binary classification there are two classes of data. The majority class includes samples from the dataset representing the normal case, and the minority class includes samples from the dataset representing the abnormal case (e.g., fault, fraud, outlier, anomaly, disease state, etc.). However, utilizing machine learning techniques, in some instances it is possible that a classifier may classifier a majority class sample as a sample from the minority class (e.g., “FP” or false positive). In other words, a “normal” case is identified as being in the minority class. Similarly, it is possible that the classifier may classify a minority class sample as a sample belonging to the majority class (e.g., “FN” or false negative). In the case of imbalanced datasets, reducing the amount of FN classifications is desirable.

As shown in FIG. 1, the threshold value optimization system 100 includes a prediction module 102, a pre-processing module 104, a normalization module 106, and an optimization module 108 for providing an optimal threshold value 116 from a set of input data 114. The set of input data 114 may include a dataset and a set of predetermined threshold values. For example, the dataset can comprise images, documents, listed data entries, etc. The input data 114 can also include a set of predefined threshold values utilized as part of the optimization techniques. The predefined threshold values can be a range of threshold values of which the optimal threshold value 116 can be selected from. The threshold value optimization system 100 can receive the input data 114 including the dataset and the predefined threshold values, and the threshold value optimization system 100 can perform operations on the inputs data 114 to determine the optimal threshold value 116.

The input data 114 can be received by the prediction module 102 which can perform class prediction on the input data. For example, the prediction module 102 can analyze the input dataset of the input data 114 and generate a set of class probabilities. Each sample from the input data is predicted to be associated with a particular class of a set of classes based on a selected threshold value from the set of predefined threshold values and a class probability. For instance, the dataset may represent an imbalanced dataset where the number of true positive data elements is substantially smaller than the total number of data in the dataset. As one example, the dataset could represent a set of images associated with electronic deposits of financial checks, and the threshold value optimization system 100 could be utilized for determining an optimal threshold value 116 that may be used by a machine learning model of a classifier service to identify images that represent a fraudulent check. In this case, the dataset of images could be imbalanced such that the number of checks in a majority class (e.g., “real” checks) is substantially more than the number of checks in a minority class (e.g., “fraudulent” checks). In some examples, the number of data elements in the minority class could be less than 1% of the total number of images. In some examples, the number of data elements in the minority class could be less than 0.1% of the total number of images, and in these cases, the dataset could be referred to as a severely imbalanced dataset. In some examples, a majority-to-minority class ratio may be between 100:1 and 10,000:1. In other words, for every 10,000 “normal” or “real” data elements, there is 1 “abnormal” or “fraudulent” data elements.

Staying with FIG. 1, the prediction module 102 can receive the input samples and generate a class probability for each input sample, where the class probability represents a probability that the input sample belongs to a particular class (e.g., minority class or majority class). The probability prediction for each class can be provided to a pre-processing module 104 of the threshold value optimization system 100.

The pre-processing module 104 of the threshold value optimization system 100 can receive the class probability for each sample and based on the specific threshold value utilized by the prediction module 102 perform various pre-processing metrics that may be used by the threshold value optimization system 100 at later processing modules to determine the optimal threshold value 116. Included in the pre-processing module 104 are various metrics. For example, precision metrics 110 is included in pre-processing module 104. The precision metrics 110 can determine a set of precision values for the input samples for the range of pre-defined threshold values. Additionally, the precision metrics 110 can determine a reference precision value for the input data 114. For instance, determining a reference precision value can involve dividing the number of minority class samples by the total number of samples (e.g., data elements) in the input data 114.

Also included in the pre-processing module 104 is recall metrics 112. The recall metrics 112 can determine a set of recall values based on the pre-defined threshold values and the dataset of the input data 114. In some examples, determining the set of recall values can include, for each pre-defined threshold, dividing the total number of predicted samples in the minority class by a sum of the total number of true positive samples in the minority class added to a total number of false negative samples in the minority class. The pre-processing module 104 can iterate through each pre-defined threshold value to generate a set of recall values (e.g., a recall value for each pre-defined threshold). The precision values determined by the precision metrics 110 and the recall values determined by the recall metrics 112 may be stored in a database (not shown) of the threshold value optimization system 100 for access by other processing modules (e.g., the normalization module 106 and the optimization module 108) included in the threshold value optimization system 100.

The pre-processing module 104 of the threshold value optimization system 100 can also perform further processing on the set of precision values determined by the precision metrics 110 and the set of recall values determined by the recall metrics 112. For instance, the pre-processing module 104 can also determine a set of precision ratio values utilizing the set of precision values and the reference precision value. In this case, each of the precision values generated by the precision metrics 110 may be divided by the reference precision value to generate the set of precision ratio values.

The pre-processing module 104 can provide the generated set of precision ratio values and set of recall values to a normalization module 106. The normalization module 106 can perform further processing steps to normalize the data. In one example, the normalization module 106 can normalize the set of precision ratio values generated by the pre-processing module 104. Normalizing the set of precision ratio values can involve determining a maximum precision ratio value from the set of precision ratio values and then dividing each precision ratio value by the determined maximum to thereby generate a set of normalized precision ratio values.

After generating the set of normalized precision ratio values, the normalization module 106 can perform further processing using the normalized precision ratio values and the set of recall values provided by the pre-processing module 104. For instance, the normalization module 106 can compute a set of normalized lift ratios. The normalized lift ratios can represent a harmonic average of the normalized precision ratio values and the set of recall values. The harmonic average representing the set of normalized lift ratios may be expressed by the following equation:

$$Normalized lift {ratio}_{l} = \frac{2}{\frac{1}{{recall}_{l}} + \frac{1}{Normalized Precision Ratio {Value}_{l}}}$$

As expressed in the equation above, recall represents the recall value for each predefined threshold value, and Normalized Precision Ratioₗ represents the normalized set of precision ratio values.

The set of normalized lift ratios can then be provided to an optimization module 108. The optimization module 108 can perform processing on the set of normalized lift ratios to determine the optimal threshold value 116. Determining the optimal threshold value 116 involves determining a maximum value from the set of normalized lift ratios where the determined maximum represents the optimal threshold value 116. The optimal threshold value 116 provides a tradeoff between recall and the normalized precision ratio, which as is evident by the preceding processing steps, is associated with precision of the classifier. The optimal threshold value 116 may be utilized to classify input data using the set of class probabilities and the optimal threshold value generated by the pretrained machine learning model of the classifier service.

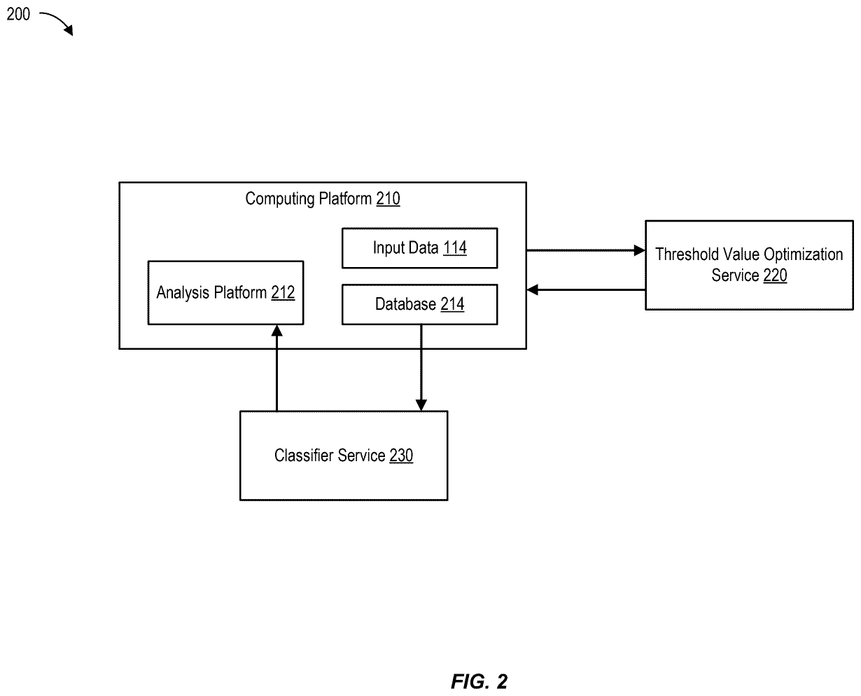

FIG. 2 is a block diagram illustrating an example computing environment 200 used for threshold value optimization, according to one or more aspects of the present disclosure. The computing environment 200 may include a computing platform 210. In an example the computing platform 210 may run on a client computer, while a threshold value optimization service 220 and classifier service 230 are run on remote computing devices, such as in a cloud computing system. In other examples, one or more of the threshold value optimization service 220 and classifier service 230 may also be run locally on the computing platform 210 client computer.

The computing platform 210 may provide access to the input data 114 by the threshold value optimization service 220, which may include the threshold value optimization system 100 described in relation to FIG. 1. Further, outputs of the threshold value optimization service 220, such as the optimal threshold value 116 of the threshold value optimization system 100, may be stored in database 214 of the computing platform 210. Database 214 may also store the input data 114 including the dataset and predefined threshold values described in relation to FIG. 1. In an example, the input data 114 stored in the database 214 of the computing platform 210 are stored in a manner that enables access to the input data 114 by the threshold value optimization service 220. As previously mentioned, the input data 114 stored in the database 214 and access by the threshold value optimization service 220 may be stored and performed locally with the threshold value optimization system 100, or the threshold value optimization service 220 may access the input data 114 from the database 214 from a remote location. In this case, the threshold value optimization service 220 can include additional microservices that are able to fetch the input data 114 from the database 214 and process the input data 114. The threshold value optimization service 220 can include other microservices such as the prediction module 102, pre-processing module 104, normalization module 106, and optimization module 108 described in relation to FIG. 1. In other words, the threshold value optimization service 220 may run the microservices of the threshold value optimization system 100 and to determine the optimal threshold value 116. The optimal threshold value 116 may be displayed by, accessed within, or provided to the computing platform 210 for use by the classifier service 230.

As described herein, classifier service 230 can be a classifier that includes a machine learning model. The machine learning model can utilize the optimal threshold value 116 determined by the threshold value optimization service 220 to classify the input data. As described throughout the present disclosure, selecting an optimal threshold value 116 leverages the idea of using a random classifier with no-skills to benchmark the performance of the trained classifier. Optimizing the performance of the classifier is accomplished by establishing a performance metric referred to as normalized lift ratio, which effectively balances relevancy of predictions and the number of relevant predictions. In other words, the determined optimal threshold value 116 provides a meaningful tradeoff between the number of correctly predicted minority class predictions and the relevancy of all minority class prediction as well as the ability to select a specific threshold value by providing a distinct optimum point (e.g., maximum) on the normalized lift ratio curve.

Classifier service 230 may use the optimal threshold value 116 determined by the threshold value optimization service 220 and make a prediction using a machine learning model. The machine learning model may be a supervised machine-learning model. The performance of the classifier service 230 can be provided to an analysis platform 212. Analysis platform 212 can analyze the performance of the classifier by analyzing various metrics such as accuracy of predictions, precision, recall, etc. In one example, the analysis platform 212 can compare the performance of the classifier service 230 with other features such as a cost function to determine how well the threshold value optimization service 220 is selecting at optimal threshold value 116. One of ordinary skill in the art would recognize many variations, modifications, and alternatives.

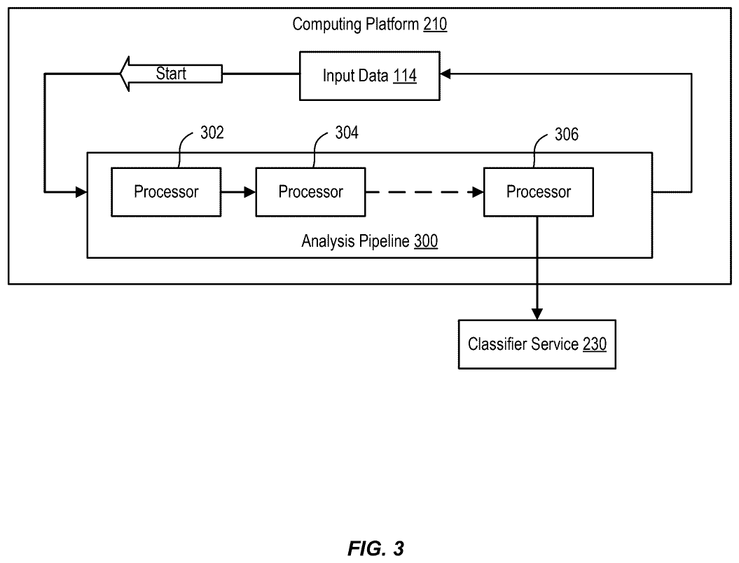

FIG. 3 is a block diagram illustrating an example analysis pipeline of the computing platform of FIG. 2 used for threshold value optimization, according to one or more aspects of the present disclosure. As shown in FIG. 3, input data 114 may be added to the computing platform 210. As discussed previously, input data 114 can refer to a dataset of images, documents, or other data elements. Upon receipt of the input data 114 at the computing platform 210, the analysis pipeline 300 processes the input data. In one example, the analysis pipeline 300 can include multiple processors 302 and 304 to process the input data 114. For example, processor 302 may perform the operations associated with the prediction module 102, processor 304 may perform the operations associated with the pre-processing module 104, and so on. Other operations, such as the operations performed by the normalization module 106 and the optimization module 108 may be performed by additional processors (not illustrated) of the analysis pipeline 300.

After processing the input data 114, a processor 306 may request the classifier service 230. The machine learning model of the classifier service 230 can be a binary classifier or a multi-class classifier that is trained to classify input samples, such as input data 114. The optimal threshold value 116 provided to the classifier service 230 can be utilized by the classifier service 230 to classify the input data more effectively to thereby optimize the performance of the machine learning model of the classifier service 230 by providing a balance between precision and recall of the classifier service 230. In other words, the classifier service 230 may receive the optimal threshold value 116 and return a prediction to the processor 306 assigning the data in the dataset to its appropriate class. This prediction may be displayed, accessed, or searched by a user of the computing platform 210 for analytical purposes.

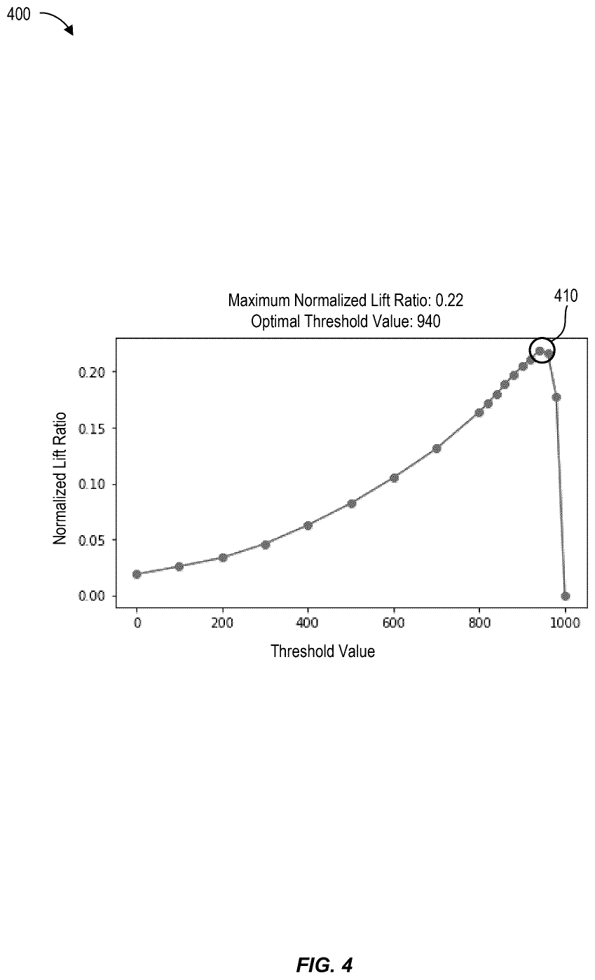

FIG. 4 is an example plot 400 of normalized lift ratios verses threshold values, according to one or more aspects of the present disclosure. The plot 400 illustrated in FIG. 4 may represent a plot generated by the normalization module 106 as described in relation to FIG. 1. The plot 400 may be used by the optimization module 108 to determine the optimal threshold value 116. As shown in FIG. 4, selecting a maximum value 410 from the set of normalized lift ratios provides the optimal threshold value 116 for use by a classifier. The optimal threshold value 116 may be provided to a classifier, such as classifier service 230 described in relation to FIGS. 2 and 3.

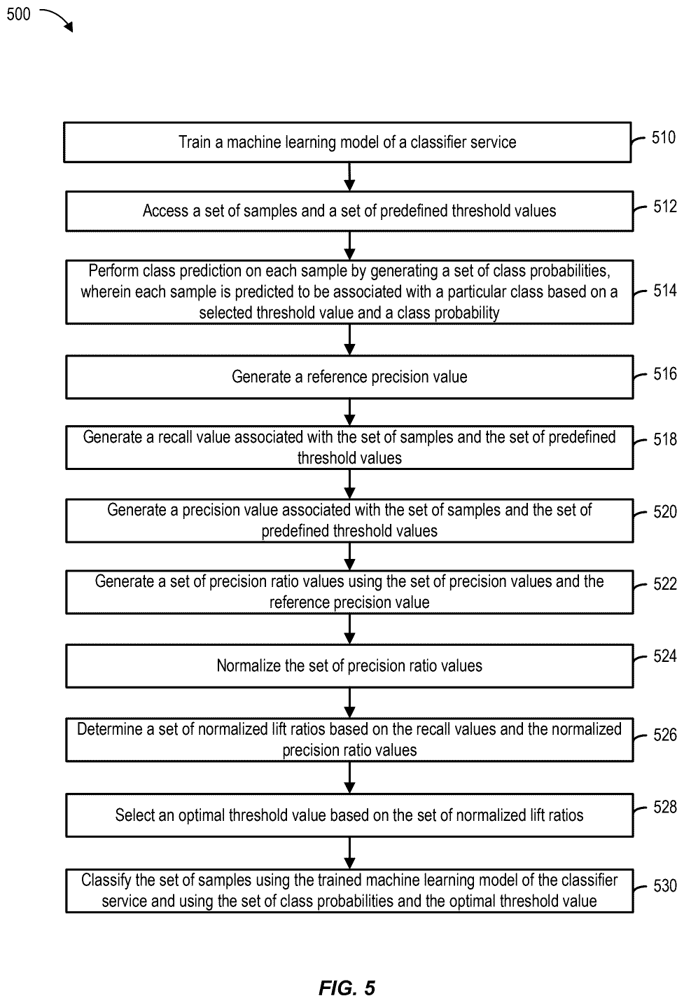

FIG. 5 is a flowchart of an example of a process 500 for selecting an optimal threshold value for a pretrained machine learning model of a classifier service, according to one or more aspects of the present disclosure. The steps illustrated by process 500 may be performed, for example, by one or more processors of a computing device operating as a separate system, such as threshold value optimization system 100 of FIG. 1, or as part of a computing platform, such as computing platform 210 of FIG. 2. For the sake of simplicity, the steps illustrated in process 500 and described below, are described in relation to being performed by a processor, although variations and other configurations are possible.

As illustrated, process 500 may begin at block 510 in which a processor can train a machine learning model of a classifier service. Training the machine learning model can generate a pretrained machine learning model that may be used to implement the techniques described herein. Additionally, as previously mentioned, the classifier service may be associated with a binary classifier service or a multi-class classifier service.

At block 512, the processor can access a set of samples and a set of predefined threshold values. The set of samples and the set of predefined threshold values can comprise input data, such as input data 114 discussed in relation to FIGS. 1-3. For example, the input data may include a dataset that comprises images, documents, listed data entries, etc. and a set of predefined threshold values utilized as part of the optimization techniques. The predefined threshold values can be a range of threshold values from which the optimal threshold value is selected.

At block 514, the processor can perform class prediction on each sample of the set of samples by generating a set of class probabilities. Each sample can be predicted to be associated with a particular class based on a selected threshold value from the predefined threshold values and a class probability. As mentioned previously, and in the case of an imbalanced dataset, performing class prediction on the set of samples can involve predicting whether a sample belongs to a particular class (e.g., a minority class or a majority class) based on a specific threshold value and a class probability.

At block 516, the processor can generate a reference precision value. Generating a reference precision value can involve dividing a number of samples associated with the minority class by a sum of the number of samples associated with the minority class and a number of samples associated with the majority class. Additionally, and as one of ordinary skill will appreciate, the sum of the number of samples associated with the minority class and a number of samples associated with the majority class is equivalent to a total number of samples in the input dataset. Thus, the reference precision value is a metric corresponding to the number of samples in the minority class (e.g., true positive cases) divided by the total number of samples in the input data.

At block 518, the processor can generate a recall value associated with the set of samples and the set of predefined threshold values. In other words, for a given threshold value from the predefined threshold values, a recall value can be computed using the following equation:

$$Recall = \frac{TP}{TP + FN}$$

As mentioned previously, TP represents the number of true positive samples in the minority class, and FN represents the number of false negative samples (e.g., samples that are incorrectly predicted to be in the majority class for each given threshold).

At block 520, the processor can generate a precision value associated with the set of samples and the set of predefined threshold values. In other words, for a given threshold value from the predefined threshold values, a recall value can be computed using the following equation:

$$Precision = \frac{TP}{TP + FP}$$

As mentioned previously, and similar to the recall equation above, TP represents the number of true positive samples in the minority class, and FP represents the number of false positive samples (e.g., samples that are incorrectly predicted to be in the minority class). Additionally, and as previously discussed in relation to FIGS. 1-4, these metrics (e.g., the reference precision value, set of recall values, the set of precision values etc.) may be stored in a database for access by the processor.

At block 522, the processor can generate a set of precision ratio values using the set of precision values and the reference precision value. Generating the set of precision ratio values can involve dividing each precision value by the reference precision value.

At block 524, the processor can normalize the set of precision ratio values. Normalizing the set of precision ratio values can involve first determining a maximum precision ratio value of the set of precision ratio values. Next, normalizing the set of precision ratio values can involve dividing each precision ratio value by the maximum precision ratio value.

At block 526, the processor can determine a set of normalized lift ratios based on the recall values and the normalized precision ratio values. Determining the set of normalized lift ratios includes determining a harmonic average of the set of normalize precision ratio value and the set of recall values. The harmonic average representing the set of normalized lift ratios may be expressed by the following equation:

$$Normalized lift {ratio}_{l} = \frac{2}{\frac{1}{{recall}_{l}} + \frac{1}{Normalized Precision Ratio {Value}_{l}}}$$

As expressed in the equation above, recall represents the recall value for each predefined threshold value, and Normalized Precision Ratioₗ represents the normalized set of precision ratio values.

At block 528, the processor can select an optimal threshold value based on the set of normalize lift ratios. After the set of normalized lift ratios are generated, the processor can select the optimal threshold value from the set of normalized lift ratios. Selecting the optimal threshold value includes determining a maximum value of the set of normalized lift ratios.

At block 530, the processor can classify the set of samples using the set of class probabilities and the optimal threshold value. In other words, the optimal threshold value is provided to a classifier service and used to perform classification (e.g., binary classification or multi-class classification) on input datasets.

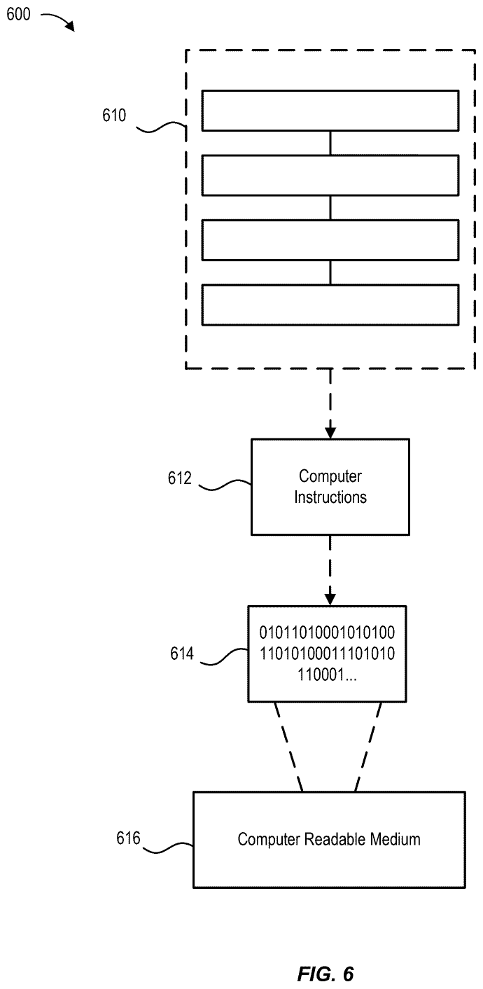

One or more of the aspects of the present disclosure include a computer-readable medium including microprocessor or processor-executable instructions configured to implement one or more embodiments presented herein. FIG. 6 is a block diagram illustrating an example computer-readable medium or computer-readable device including processor-executable instructions configured to embody one or more of the aspects set forth herein. As illustrated in FIG. 6, implementation 600 includes a computer-readable medium 616. Computer-readable medium 616 can include a CD-R, DVD-R, flash drive, a platter of a hard disk drive, and so forth, on which computer-readable data 614 is encoded and stored. The computer-readable data 614, such as binary data including a plurality of zero's and one's as illustrated, in turn includes a set of computer instructions 612 configured to operate according to one or more of the principles set forth herein.

In the illustrated implementation 600 of FIG. 6, the set of computer instructions 612 (e.g., processor-executable computer instructions) may be configured to perform a method 610, such as the process 500 of FIG. 5, for example. In another embodiment, the set of computer instructions 612 may be configured to implement a system, such as the threshold value optimization system 100 of FIG. 1, for example. Many such computer-readable media may be devised by those of ordinary skill in the art that are configured to operate in accordance with the techniques presented herein.

As used in this application, the terms “component,” “module,” “system,” “interface,” “manager,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

A device may also be called and may contain some or all of the functionality of a system, subscriber unit, subscriber station, mobile station, mobile, mobile device, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WALL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects may also be implemented with wired devices, or with both wired and wireless devices.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

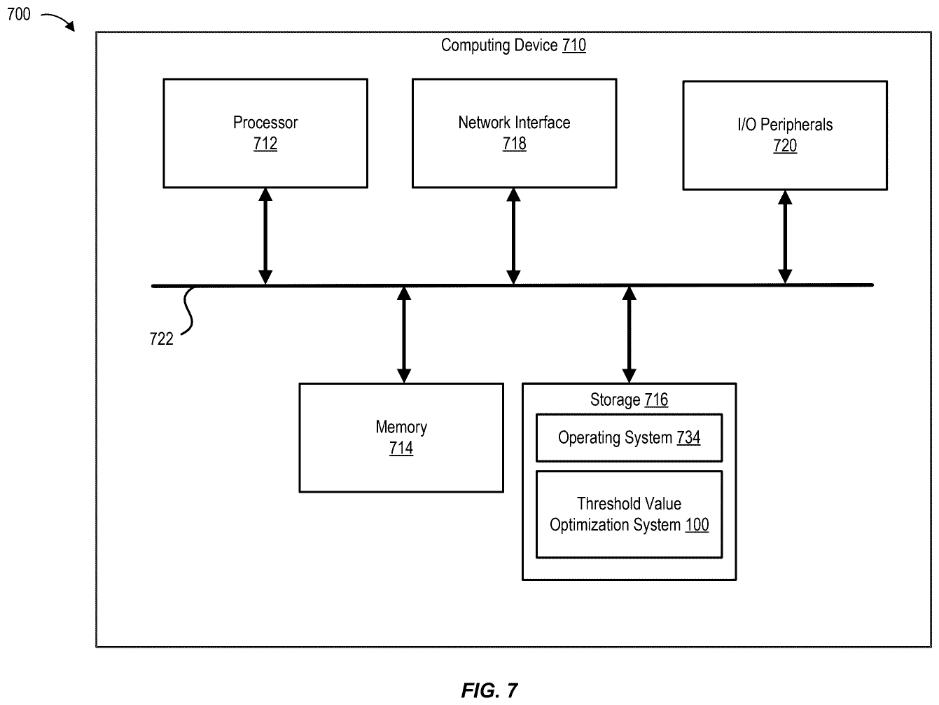

FIG. 7 and the following discussion provide a description of a suitable computing environment 700 to implement embodiments of one or more of the aspects set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, application programming interfaces (APIs), data structures, and the like, which perform one or more tasks or implement one or more abstract data types. Typically, the functionality of the computer readable instructions is combined or distributed as desired in various environments.

FIG. 7 is a block diagram illustrating an example computing environment 700 for implementing a command executor module, according to one or more aspects of the present disclosure. In one configuration, the computing device 710 may include at least one processor 712 and at least one memory 714. Depending on the exact configuration and type of computing device, the at least one memory 714 may be volatile, such as RAM, non-volatile, such as ROM, flash memory, etc., or a combination thereof. Examples of processor 712 include a microprocessor, an application-specific integrated circuit (ASIC), a field-programmable gate array (FPGA), or any other suitable processing device. Computing device 710 can include one processor, such as is illustrated by processor 712 in FIG. 7, or more than one processor.

Computing device 710 may include additional features or functionality. For example, the computing device 710 may include storage such as removable storage or non-removable storage, including, but not limited to, magnetic storage, optical storage, etc. Such storage is illustrated in FIG. 7 by storage 716. In one or more embodiments, computer readable instructions to implement one or more embodiments provided herein are in the storage 716. The storage 716 may store other computer readable instructions to implement an operating system, an application program, etc. Computer readable instructions may be loaded in the at least one memory 714 for execution by the at least one processor 712, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Still referring to FIG. 7, the computing environment 700 may also include a number of additional external or internal devices, for example, input or output devices. For example, computing device 710 is illustrated as including input/output (I/O) peripherals 720. I/O peripherals 720 can receive input from an input device (not shown) or provide output to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the computing device 710.

I/O peripherals 720 may be connected to the computing device 710 via a wired connection, wireless connection, or any combination thereof. Further, the computing device 710 may include network interface 718 to facilitate communications with one or more other devices (not shown). Network interface 718 can include any device or group of devices suitable for establishing a wired or wireless data connection to one or more data networks. Non-limiting examples of the network interface 718 include an Ethernet network adaptor, a wireless network adapter, a modem, Wi-Fi adapter, Bluetooth adapter, near field communication (NFC) receiver and transmitter, and any other known wired or wireless data transmission system.

Computing device 710 also includes interface bus 722. Although only one interface bus is illustrated, computing environment 700 can include more than one interface bus. Interface bus 722 can communicatively couple one or more components of computing device 710.

Staying with FIG. 7, computing environment 700 includes one or more programs and/or program data that may be accessible in storage 716 by the computing device 710. For example, storage 716 can store an operating system 734 utilized to control the operation of the computing device 710. Storage 716 can also store other system of application programs and data utilized by the computing device 710, such as modules implementing the functionalities provided by the threshold value optimization system 100 or any other functionalities described above with respect to FIGS. 1-6. The storage 716 may also store other programs and data not specifically identified herein.

### General Considerations

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for case of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method of selecting an optimal threshold value for a pretrained machine learning model of a classifier service, the method comprising:
accessing a set of samples and a set of predefined threshold values;
performing class prediction on each sample of the set of samples using a prediction module to generate a set of class probabilities wherein, each sample of the set of samples is predicted to be associated with a particular class of a set of classes based on a selected threshold value from the set of predefined threshold values and a class probability;
generating a reference precision value using a pre-processing module;
generating, using the pre-processing module, a recall value associated with each predefined threshold value to thereby generate a set of recall values;
generating, using the pre-processing module, a set of precision values associated with each predefined threshold value to thereby generate a set of precision values;
generating a set of precision ratio values using the pre-processing module, wherein generating the set of precision ratio values comprises dividing each precision value by the reference precision value;
normalizing the set of precision ratio values using a normalization module to thereby generate a normalized set of precision ratio values by:
determining a maximum precision ratio value of the set of precision ratio values; and
dividing each precision ratio value by the maximum precision ratio value;
providing the set of recall values and the normalized set of precision ratio values to an optimization module;
determining a set of normalized lift ratios based on the set of recall values and the normalized set of precision ratio values;
selecting an optimal threshold value based on the set of normalized lift ratios; and
classifying the set of samples using the optimal threshold value and the set of class probabilities generated by the pretrained machine learning model of the classifier service.

2. The method of claim 1, wherein the set of normalized lift ratios comprises a harmonic average of the set of normalized precision ratio values and the set of recall values.

3. The method of claim 2, wherein selecting the optimal threshold value comprises determining a maximum value of the harmonic average.

4. The method of claim 1, wherein a first class of the set of classes is associated with a majority class of the set of samples, and wherein a second class of the set of classes is associated with a minority class of the set of samples.

5. The method of claim 4, wherein a number of samples in the second class is less than 0.1% of a total number of samples.

6. The method of claim 4 wherein, generating the reference precision value comprises dividing a number of samples associated with the minority class by a sum of the number of samples associated with the minority class and a number of samples associated with the majority class.

7. The method of claim 1, wherein the set of samples represents an imbalanced dataset.

8. A system comprising:
one or more processors;
a memory coupled to the one or more processors, the memory including instructions that, when executed by the one or more processors, cause the one or more processors to:
access a set of samples and a set of predefined threshold values;
perform class prediction on each sample of the set of samples using a prediction module to generate a set of class probabilities wherein, each sample of the set of samples is predicted to be associated with a particular class of a set of classes based on a selected threshold value from the set of predefined threshold values and a class probability;
generate a reference precision value associated using a pre-processing module;
generate a recall value associated with each predefined threshold value using the pre-processing module to thereby generate a set of recall values;
generate a precision value associated with each predefined threshold value using the pre-processing module to thereby generate a set of precision values;
generate a set of precision ratio values using the pre-processing module, wherein generating the set of precision ratio values comprises dividing each precision value by the reference precision value;
normalize the set of precision ratio values using a normalization module to thereby generate a normalized set of precision ratio values by:
determining a maximum precision ratio value of the set of precision ratio values; and
dividing each precision ratio value by the maximum precision ratio value;
provide the set of recall values and the normalized set of precision ratio values to an optimization module;
determine a set of normalized lift ratios based on the set of recall values and the normalized set of precision ratio values;
select an optimal threshold value based on the set of normalized lift ratios; and
classify the set of samples using the set of class probabilities and the optimal threshold value.

9. The system of claim 8, wherein the set of normalized lift ratios comprises a harmonic average of the set of normalized precision ratio values and the set of recall values.

10. The system of claim 9, wherein selecting the optimal threshold value comprises determining a maximum value of the harmonic average.

11. The system of claim 8, wherein a first class is associated with a majority class of the set of samples, and wherein a second class is associated with a minority class of the set of samples.

12. The system of claim 11, and wherein a number of samples in the second class is less than 0.1% of a total number of samples.

13. The system of claim 11, wherein generating the reference precision value comprises dividing a number of samples associated with the minority class by a sum of the number of samples associated with the minority class and a number of samples associated with the majority class.

14. The system of claim 8, wherein the set of samples represents an imbalanced dataset.

15. A non-transitory computer-readable medium embodying program code that is executable by one or more processors to cause the one or more processors to:
access a set of samples and a set of predefined threshold values;
perform class prediction on each sample of the set of samples using a prediction module to generate a set of class probabilities wherein, each sample of the set of samples is predicted to be associated with a particular class of a set of classes based on a selected threshold value from the set of predefined threshold values and a class probability;
generate a reference precision value associated using a pre-processing module;
generate a recall value associated with each predefined threshold value using the pre-processing module to thereby generate a set of recall values;
generate a precision value associated with each predefined threshold value using the pre-processing module to thereby generate a set of precision values;
generate a set of precision ratio values using the pre-processing module, wherein generating the set of precision ratio values comprises dividing each precision value by the reference precision value;
normalize the set of precision ratio values using a normalization module to thereby generate a normalized set of precision ratio values by:
determining a maximum precision ratio value of the set of precision ratio values; and
dividing each precision ratio value by the maximum precision ratio value;
provide the set of recall values and the normalized set of precision ratio values to an optimization module;
determine a set of normalized lift ratios based on the set of recall values and the normalized set of precision ratio values;
select an optimal threshold value based on the set of normalized lift ratios; and
classify the set of samples using the set of class probabilities and the optimal threshold value.

16. The non-transitory computer-readable medium of claim 15, wherein the set of normalized lift ratios comprises a harmonic average of the set of normalized precision ratio values and the set of recall values.

17. The non-transitory computer-readable medium of claim 16, wherein selecting the optimal threshold value comprises determining a maximum value of the harmonic average.

18. The non-transitory computer-readable medium of claim 15, wherein a first class is associated with a majority class of the set of samples, and wherein a second class is associated with a minority class of the set of samples.

19. The non-transitory computer-readable medium of claim 18, wherein the set of samples represents an imbalanced dataset, and wherein a number of samples in the second class is less than 0.1% of a total number of samples.

20. The non-transitory computer-readable medium of claim 18, wherein generating the reference precision value comprises dividing a number of samples associated with the minority class by a sum of the number of samples associated with the minority class and a number of samples associated with the majority class.
